(19) United States
(12) Patent Application Publication
(10) Pub. No.: US 2018/0137613 A1
(43) Pub. Date: May 17, 2018

(54) METHOD FOR ONLINE CONFIGURATION AND ORDERING

(71) Applicant: Endress+Hauser Conducta GmbH+Co. KG, Gerlingen (DE)

(72) Inventors: Guido Mennicken, Leonberg (DE); Sebastian Schmidt, Stuttgart (DE); Maximiliane Bayo, Tubingen (DE)

(21) Appl. No.: 15/804,144

(22) Filed: Nov. 6, 2017

(30) Foreign Application Priority Data
Nov. 17, 2016 (DE) 10 2016 122 163.5

(51) Int. Cl. G06T 7/00; G06Q 30/06; G06T 7/70; G06K 9/64

(52) U.S. Cl. CPC G06T 7/001; G06Q 30/0633; G06T 2207/30164; G06T 7/70; G06K 9/64; G06T 7/0008

(57) ABSTRACT

The present disclosure relates to a method for determining missing and/or incorrectly positioned field device components of a field device using a stored field device configuration, comprising: creating a digital image of the field device, extracting at least one object and its position in the field device from the image, comparing the object and its position with stored images of field device components and their positions in a field device, identifying the object as a field device component and its position based upon the comparison, determining a field device configuration using the identified field device component and its position in the form of a digital code, comparing the determined field device configuration with the field device configuration of the stored image, and determining the missing and/or incorrectly positioned field device components based upon the comparison.

### CROSS-REFERENCE TO RELATED APPLICATION

The present application is related to and claims the priority benefit of German Patent Application No. 10 2016 122 163.5, filed on Nov. 17, 2016, the entire contents of which are incorporated herein by reference.

### TECHNICAL FIELD

The present disclosure relates to a computer-aided method for online configuration and ordering of a device by a user.

### BACKGROUND

Known methods of this type are used by users in order to select and order, on an accessible computer, one or more devices from an electronic catalog of available devices. The devices are, for example, measuring devices or measuring systems for an industrial process or an industrial plant. In industrial processes and plants, measuring devices in the form of field devices are often used. In such cases, the user determines missing field device components of a field device, which components are then selected and ordered from a stored field device configuration.

During the course of the method, the user is usually prompted to enter various field device components. He then, moreover, has the opportunity to select field device components he deems suitable from a group of suggested field devices. Generally, the user can then configure with the field devices the field device components he selected or marked and receives an order number or an order code for each field device.

There are methods of this type that run alone on the computer of the user and, at the end, generate an order form that lists the desired, marked field device components along with their order number or an order code and that can be transmitted to the manufacturer.

Other methods of this type are, for example, started on the user's computer. After a connection to a server at the manufacturer of the searched devices has been established, the two computers interact. In this case, at the end of such a procedure, the user can order online the field device components he desires and has marked directly via the computer of the manufacturer. This online ordering process via the computer of the manufacturer is time-consuming and labor-intensive.

### SUMMARY

The present disclosure is based upon the aim of specifying a quick and easy method for determining missing and/or incorrectly positioned field device components of a field device using a stored field device configuration.

The aim of the present disclosure is achieved by the subject matter of the present disclosure. The aim of the present disclosure is a method for determining missing and/or incorrectly positioned field device components of a field device using a stored field device configuration, comprising the steps:

Creating at least one digital image of the field device,

Electronically extracting at least one object and its position in the field device from the at least one image,

Electronically comparing the at least one object and its position with images, stored in a digital memory, of field device components and their positions in the field device,

Electronically identifying the at least one object as at least one field device component and its position based upon the comparison,

Electronically determining a field device configuration using the one identified field device component and its position in the form of a digital code,

Electronically comparing the determined field device configuration with the field device configuration of the image stored in the digital memory, which image was drawn upon to identify the at least one object as a field device component,

Electronically determining the missing and/or incorrectly positioned field device components based upon the comparison.

According to an advantageous development, at least one of the field device components is linked to information retrievable by the user, such as a replacement part description, repair instructions, or order information. This information is also located in the digital memory.

According to an advantageous variant, the field device has an identification, such as a name plate or a label, as a field device component, wherein the identification is linked to the operating language of the field device.

According to an advantageous embodiment, a non-relevant region of the at least one image is hidden or classified as “non-relevant.” The images, stored in the digital memory (database), of field device components and their positions in the field device show which regions of the images are non-relevant and therefore hidden.

According to an advantageous design, the at least one image of the field device is created using a smartphone, a tablet PC, smart glasses, or a next generation digital camera.

According to a favorable development, electronically extracting at least one object and its position in the field device from the at least one image, electronically comparing the at least one object and its position with images, stored in a digital memory, of field device components and their positions in the field device, and electronically identifying the at least one object as at least one field device component and its position based upon the comparison take place by means of software particularly, an application (app). The software or app is an object recognition software or an object recognition app, which runs on a portable computer in particular, an operator unit or a smartphone and can access a database with images, stored in a digital memory, of field device components and their positions in the field device. The database with the digital memory can be arranged at the user or at the field device manufacturer. The computer can access the database via an internet connection.

According to a favorable variant, the missing field device components are displayed by the computer as an order option.

### BRIEF DESCRIPTION OF THE DRAWINGS

The present disclosure is explained in more detail based upon the following drawings. Illustrated are:

FIG. 1 shows an interior view of an opened field device without bottle carrier or insulated box,

FIG. 2 shows an image of an interior view of an opened field device with bottle carrier and insulated box, and

FIG. 3 shows a top view of a terminal connection of a field device.

### DETAILED DESCRIPTION

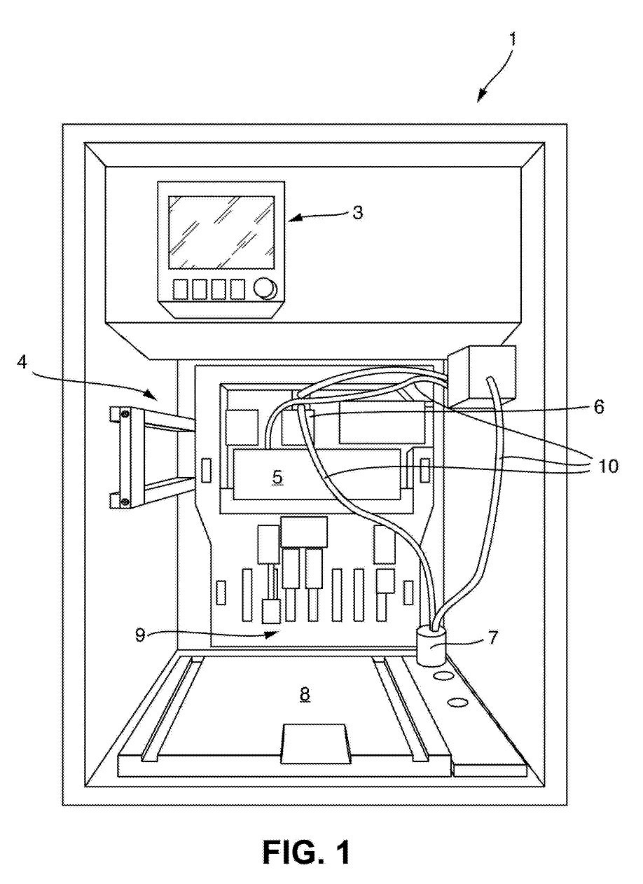

FIG. 1 shows an interior view of an opened field device 1. In an internal space of the field device 1, the following field device components are arranged at defined positions: controller 3, rail system 4, valve system 5, photometer 6, drain 7, receptacle for bottle carrier 8, syringe pump 9, and tubes 10. The method for determining missing field device components of a field device comprises the following steps. First, a digital image of an internal space of the field device 1 according to the view of FIG. 1 is created by means of a digital camera. A computer (not shown) extracts the objects from this image electronically by means of object recognition software. The same object recognition software electronically compares the objects and their positions with images, stored in a digital memory, e.g., a database, of field device components and their positions in the field device. The database can be at the user or at the manufacturer. Based upon the comparison, the object recognition software electronically identifies the objects as field device components and their positions in the field device. The object recognition software can now determine a field device configuration in the form of a digital code based upon the identified field device components and their positions. The object recognition software now compares this field device configuration with the field device configuration of the image stored in the database, which image was drawn upon to identify the at least one object as a field device component. From this comparison, the object recognition software can determine missing and/or incorrectly positioned field device components.

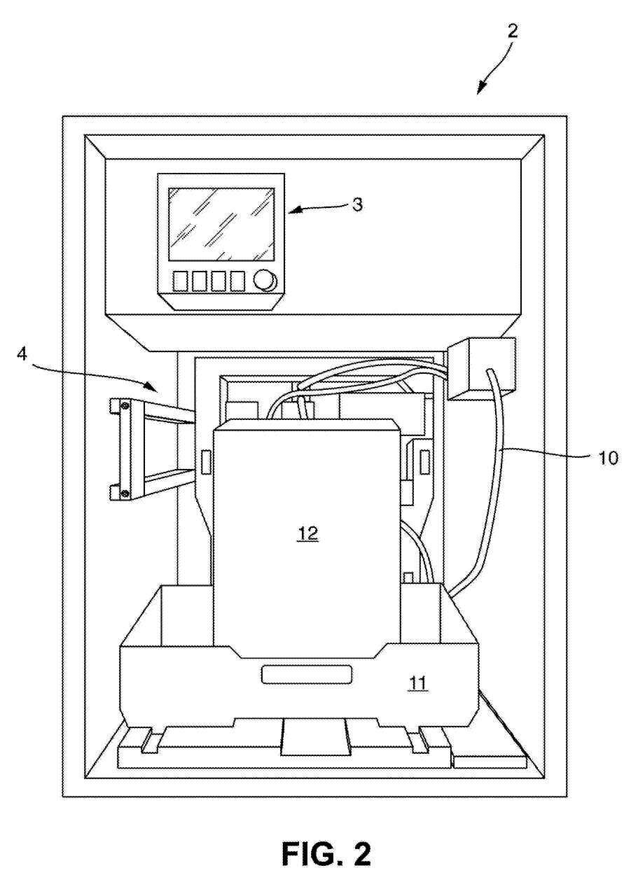

FIG. 2 shows an image 2 of an interior view of an opened field device according to FIG. 1, with additional field device components. The additional field device components are a bottle carrier 11 and an insulated box 12. The insulated box 12 is located in the bottle carrier 11, and the bottle carrier 11 is located in the receptacle for the bottle carrier 8. The image 2 is stored in a digital memory (not shown) of the computer along with the field device configuration.

The computer compares the determined field device configuration (image according to FIG. 1) with the stored field device configuration (image 2 according to FIG. 2). From this comparison, the computer determines that the bottle carrier 11 and the insulated box 12 (see FIG. 2) are missing in the field device 1 (see FIG. 1). The computer is able to autonomously order the missing bottle carrier 11 and insulated box 12 from the manufacturer via an internet connection by means of object recognition software or an object recognition application. Alternatively, the order can be displayed to a user, so that the user can confirm the order.

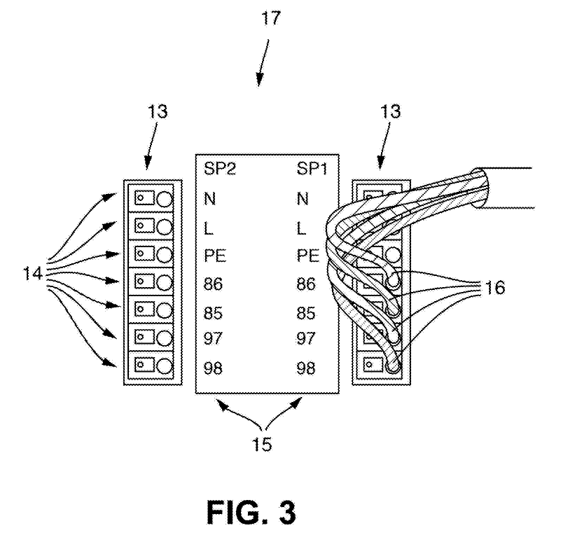

FIG. 3 shows a top view of a terminal connection 17 of a field device according to FIG. 1. The terminal connection 17 has two terminal blocks 13. Each of the terminal blocks 13 respectively has seven clamped connections 14. The clamped connections 14 respectively have a connection number 15 for identifying the respective clamped connections 14. Four connection wires 16 are connected to one of the terminal blocks 13 (see right side of FIG. 3). Each of the connection wires 16 has a different pattern identifier than the other connection wires 16. The different pattern identifiers help to better identify the connection wires 16. The four connection wires 16 are arranged on the lower clamped connections 14. This condition defines the field device configuration of the terminal connection 17.

The method for determining incorrectly positioned field device components of a field device based upon a stored field device configuration comprises the following steps. First, an image of the terminal connection 17 is created. Then, the image is analyzed by means of a computer, where it is determined which connection wire 16 is clamped into which clamped connection 14. The analysis is summarized in the form of a field device configuration. A correct field device configuration, which specifies which connection wire 16 must be clamped into which clamped connection 14, is stored in the memory. The computer compares the stored field device configuration with the determined field device configuration and can determine from this comparison whether the connection wires 16 are respectively clamped in a correct clamped connection 14 or not. If one of the connection wires 16 is clamped in the wrong clamped connection 14, the computer generates an error message which indicates this.

1. A Method for determining missing and/or incorrectly positioned field device components of a field device, comprising:
creating at least one digital image of the field device;
electronically extracting at least one object and an object position in the field device from the at least one digital image;
electronically comparing the at least one object and the object position with images, stored in a digital memory, of exemplary field device components and exemplary field device component positions in an exemplary field device;
electronically identifying the at least one object as at least one field device component and a field device component position based upon the comparison;
electronically determining a field device configuration using the one identified field device component and the one identified field device component position in the form of a digital code;
electronically comparing the determined field device configuration with a field device configuration of the images stored in the digital memory, which images were drawn upon to identify the at least one object as at least one field device component; and
electronically determining the missing and/or incorrectly positioned field device components based upon the comparison.

2. The method according to claim 1, wherein the at least one field device component is linked to information retrievable by a user.

3. The method according to claim 2, wherein the information retrievable by the user includes a replacement part description, repair instructions, or order information.

4. The method according to claim 2, wherein the at least one field device component is a field device identification, and wherein the identification is linked to an operating language of the field device.

5. The method according to claim 4, wherein the at least one field device component is a name plate or a label.

6. The method according to claim 1, wherein a non-relevant region of the at least one image is hidden or is classified as “non-relevant.”

7. The method according to claim 1, wherein the at least one image is created using a smartphone, a tablet PC, smart glasses, or a next generation digital camera.

8. The method according to claim 7, wherein electronically extracting the at least one object and the object position in the field device from the at least one digital image,
electronically comparing the at least one object and the object position with images, stored in a digital memory, of exemplary field device components and exemplary field device component positions in an exemplary field device, and
electronically identifying the at least one object as at least one field device component and a field device component position based upon the comparison take place via software.

9. The method according to claim 1, wherein the missing field device components are displayed on a computer as an order option.
